(19) United States
(12) Patent Application Publication
(10) Pub. No.: US 2016/0292599 A1
(43) Pub. Date: Oct. 6, 2016

(54) ANALYZING AND REMEDIATING OPERATIONAL RISKS IN PRODUCTION COMPUTING SYSTEMS

(71) Applicant: FMR LLC, Boston, MA (US)

(72) Inventors: Angela Cox Andrews, Raleigh, NC (US); Steven Joseph Walsh, Woburn, MA (US); John Joseph Hellmuth, Milton, MA (US)

(21) Appl. No.: 14/679,859

(22) Filed: Apr. 6, 2015

(51) Int. Cl. G06Q 10/06

(52) U.S. Cl. CPC G06Q 10/0635

(57) ABSTRACT

Methods and apparatuses are described for analyzing and remediating operational risks in production computing systems. A risk mitigation modeler of a server computing device receives risk input data from a plurality of data sources. The modeler selects a risk scenario to be applied to the input data from a plurality of risk scenarios. The modeler analyzes the input data using the selected risk scenario to identify one or more risks present in the input data. The modeler determines a risk remediation plan based upon the selected risk scenario if at least one of the identified risks meets or exceeds a risk tolerance associated with the selected scenario, where the remediation plan comprises instructions to change data elements based upon the identified risk. The modeler transmits the remediation plan to a target production computing system. The target system executes the risk remediation plan to remediate the identified risks.

### TECHNICAL FIELD

This application relates generally to methods and apparatuses, including computer program products, for analyzing and remediating operational risks in production computing systems.

### BACKGROUND

Operational risks to production computing systems have become an important concern for businesses of all sizes. Issues like fraudulent activity, transaction entry error, and employee performance concerns, and events like server compromise and/or failure, across production systems are difficult to track and even more difficult to quickly remediate once they have occurred—especially when the organization has a variety of scenarios that may engender operational risk and a spectrum of risk tolerances that are associated with the operational risk.

In addition, the typical approach when taking action to mitigate operational risks present in a production computing environment is to require a person, organization, or business to research and pull information related to risk issues or events and conduct time-intensive analysis to determine what actions should be taken to reduce the likelihood of those adverse outcomes going forward.

### SUMMARY

Therefore, what is needed is a system and method for analyzing and remediating operational risks in production computing systems that can dynamically and automatically identify such risks according to customized scenarios and generate a remediation plan that when executed by the affected production computing systems, addresses the current operational risks. The techniques described herein provide the advantages of collecting and analyzing data related to operational risks to production computing systems and allowing for creation of scenarios and tolerances which trigger automated risk mitigation plans for execution directly by target production computing systems that support the organization. The techniques described herein also provide the advantage of aggregating identified risk scenarios centrally which allows for adjustment of the risk tolerances of the scenarios as well as the mitigation action(s) that trigger when the risk tolerances are met or exceeded.

The invention, in one aspect, features a computerized method for analyzing and remediating operational risks in production computing systems. A risk mitigation modeler of a server computing device receives risk input data from a plurality of data sources and selects a risk scenario to be applied to the risk input data from a plurality of risk scenarios. The risk mitigation modeler analyzes the risk input data using the selected risk scenario to identify one or more risks present in the risk input data. The risk mitigation modeler determines a risk remediation plan based upon the selected risk scenario if at least one of the identified risks meets or exceeds a risk tolerance associated with the selected risk scenario, wherein the risk remediation plan comprises instructions to change one or more data elements based upon the identified risk. The risk mitigation modeler transmits the risk remediation plan to a target production computing system. The target production computing system executes the risk remediation plan to remediate the identified risks.

The invention, in another aspect, features a computerized system for analyzing and remediating operational risks in production computing systems. The system comprises a risk mitigation modeler of a server computing device and a target production computing system. The risk mitigation modeler is configured to receive risk input data from a plurality of data sources, select a risk scenario to be applied to the risk input data, analyze the risk input data using the selected risk scenario to identify one or more risks present in the risk input data, and determine a risk remediation plan based upon the selected risk scenario if at least one of the identified risks meets or exceeds a risk tolerance associated with the selected risk scenario, wherein the risk remediation plan comprises instructions to change one or more data elements based upon the identified risk. The target production computing system is configured to receive the risk remediation plan from the risk mitigation modeler and execute the risk remediation plan to remediate the identified risks.

The invention, in another aspect, features a computer program product, tangibly embodied in a non-transitory computer readable storage medium, for analyzing and remediating operational risks in production computing systems. The computer program product includes instructions operable to cause a risk mitigation modeler of a server computing device to receive risk input data from a plurality of data sources and select a risk scenario to be applied to the risk input data, analyze the risk input data using the selected risk scenario to identify one or more risks present in the risk input data. The computer program product includes instructions operable to cause the risk mitigation modeler to determine a risk remediation plan based upon the selected risk scenario if at least one of the identified risks meets or exceeds a risk tolerance associated with the selected risk scenario, wherein the risk remediation plan comprises instructions to change one or more data elements based upon the identified risk, and transmit the risk remediation plan to a target production computing system for execution to remediate the identified risks.

Any of the above aspects can include one or more of the following features. In some embodiments, the target production computing system transmits one or more data elements associated with execution of the risk remediation plan to be used by the risk mitigation modeler as risk input data. In some embodiments, the one or more risks present in the risk input data include transaction data entry error, unauthorized data access, data security risks, fraudulent transaction activity, fraudulent account activity, business operational risks, server compromise, and server failure.

In some embodiments, the risk remediation plan is a batch job that, when executed, changes data flags in the target production computing system. In some embodiments, the risk remediation plan is a batch job that, when executed, populates data fields in the target production computing system. In some embodiments, the risk remediation plan is a command that, when executed, updates a transaction routing table in the target production computing system. In some embodiments, the risk remediation plan is a command that, when executed, updates a network traffic routing table in the target production computing system.

In some embodiments, the risk mitigation modeler transmits the risk remediation plan to a plurality of target production computing systems and each target production computing system executes at least a portion of the risk remediation plan. In some embodiments, the risk mitigation modeler generates a display of the risk input data, the selected risk scenario, and the risk remediation plan, and transmits the display to a remote computing device.

In some embodiments, the risk tolerance comprises a number of risks identified over a predetermined time period. In some embodiments, the risk mitigation modeler stores the risk input data in a data store and uses the stored risk input data to modify the risk scenarios. In some embodiments, the risk scenarios are generated based upon input received from a remote computing device.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for analyzing and remediating operational risks in production computing systems.

FIG. 2 is a flow diagram of a method for analyzing and remediating operational risks in production computing systems.

FIG. 3 is a block diagram of a system for analyzing and remediating process quality control risks.

FIG. 4 is a block diagram of a system for analyzing and remediating employee error and security risks.

FIG. 5 is a block diagram of a system for analyzing and remediating fraudulent transaction risks.

FIG. 6 is a block diagram of a system for analyzing and remediating server failure/compromise risks.

### DETAILED DESCRIPTION

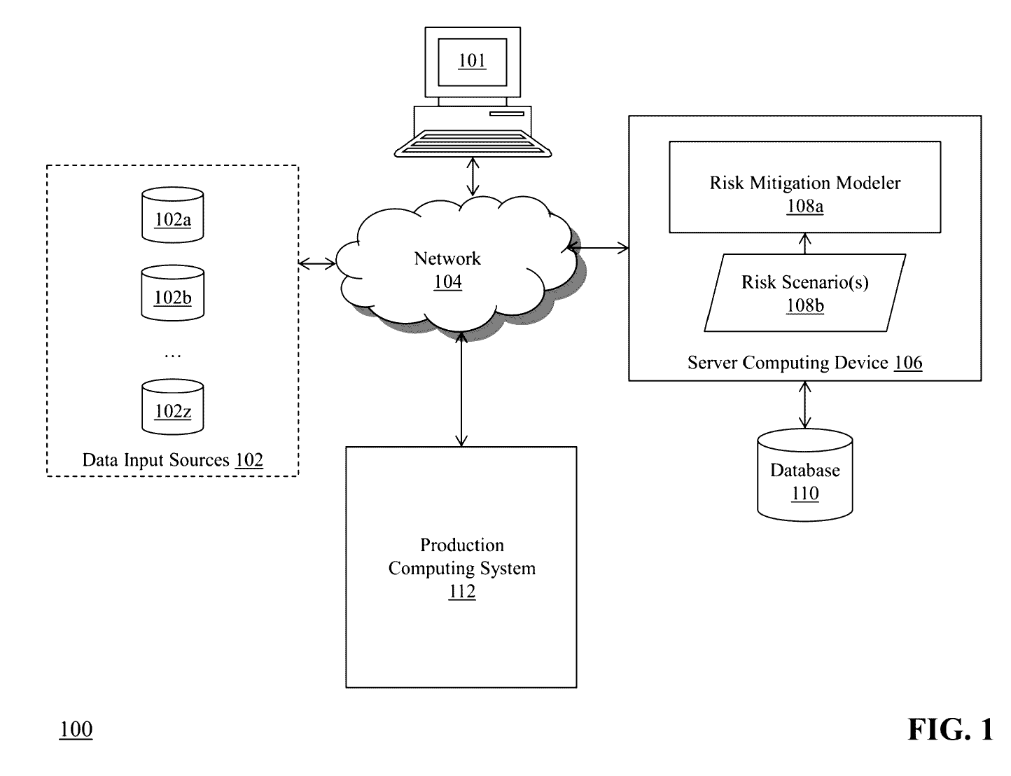

FIG. 1 is a block diagram of a system 100 for analyzing and remediating operational risks in production computing systems. The system 100 includes a client device 101, a plurality of data input sources 102a-102z (collectively, 102), a communications network 104, a server computing device 106 with a risk mitigation modeler 108a and one or more risk scenarios 108b, a database 110, and a production computing system 112.

The client device 101 connects to the communications network 104 in order to communicate with the other components in the system 100 to provide input and receive output relating to the process of analyzing and remediating operational risks in production computing systems described herein. Exemplary client devices include desktop computers, laptop computers, tablets, mobile devices, smartphones, and interne appliances. It should be appreciated that other types of computing devices that are capable of connecting to the communications network 104 and the other components of the system 100 can be used without departing from the scope of invention. Although FIG. 1 depicts a single client device 101, it should be appreciated that the system 100 can include any number of client devices. In some embodiments, the client device 101 also includes a display for receiving data from the other components of the system 100 and displaying the data to a user of the client device 101.

The data input sources 102 transmit risk input data to the other components of the system 100. The risk input data generally comprises information relating to a wide array of operational characteristics pertaining to a production computing system that, when analyzed as described herein, provide an indication of potential or actual risk to the operation and/or security of the production computing system. Such risks can include, but are not limited to, data integrity risks, employee performance risks, data security risks, fraudulent transaction risks, business operations risks, server compromise/failure risks, and so forth. It should be appreciated that other types of risks can be contemplated to fall within the scope of the invention described herein.

The communication network 104 enables the other components of the system 100 to communicate with each other in order to perform the process of analyzing and remediating operational risks in production computing systems as described herein. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The risk mitigation modeler 108a of the server computing device 106 receives risk input data from the plurality of data sources 102 for analysis based upon one or more risk scenarios 108b to identify the presence of risks in the input data and to generate a risk remediation plan to remediate the identified risks and mitigate the potential for future risks in a target production computing system. The risk mitigation modeler 108a is a specialized hardware and/or software module executing within the server computing device 106 to perform the risk analysis and mitigation process described herein. In some embodiments, the functionality of the risk mitigation modeler 108a can be distributed among a plurality of computing devices. It should be appreciated that any number of computing devices, arranged in a variety of architectures, resources, and configurations (e.g., cluster computing, virtual computing, cloud computing) can be used without departing from the scope of the invention. The exemplary functionality of the risk mitigation modeler 108a will be described in detail below.

The risk scenario 108b comprises criteria that may be found in the risk input data to show the presence of a risk as described above. The modeler 108a can retrieve the scenario 108b from a database (e.g., database 110) or, in some embodiments, the scenario 108b is defined by a user at client device 101 and transmitted to the risk mitigation modeler 108a for use in analyzing the risk input data.

As will be described in greater detail below, the criteria include a risk tolerance data element that acts as a threshold for the risk mitigation modeler 108a to determine when a risk is present in the risk input data and, in some cases, a relative severity or importance of the risk. For example, the risk mitigation modeler 108a can determine that the risk input data meets or exceeds the risk tolerance for a particular risk scenario—thereby indicating that a risk is present and prompting the modeler 108a to take corrective action. In some cases, a risk scenario can have multiple risk tolerances that relate to different risks and/or have a tiered risk scenario where a particular risk is associated with different risk tolerances that relate to a relative severity of the risk. In this case, the modeler 108a can generate different action plans based upon the severity of the risk identified.

The system 100 also includes a database 110. The database 110 is coupled to the server computing device 106 and stores data used by the risk mitigation modeler 108a to perform the risk analysis and mitigation process. The database 110 can be integrated with the server computing device 106 or be located on a separate computing device. An example database that can be used with the system 100 is MySQL™ available from Oracle Corp. of Redwood City, Calif.

The system 100 also includes a production computing system 112. The production computing system 112 comprises one or more computing devices configured to store data and perform processing relating to one or more aspects of the operations for an organization (e.g., transaction processing for a financial services organization) for which the modeler 108a identifies risks as mentioned above.

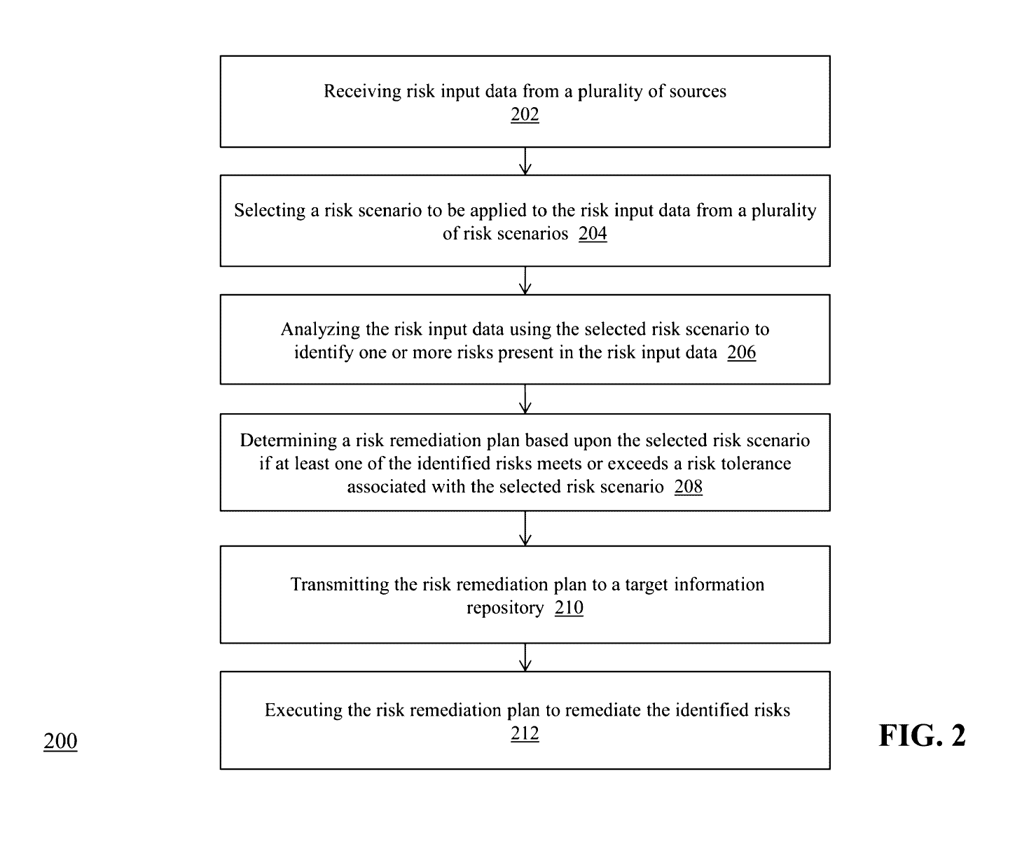

FIG. 2 is a flow diagram of a method 200 for analyzing and remediating operational risks in production computing systems, using the system 100 of FIG. 1. The risk mitigation modeler 108a in the server computing device 106 receives (202) risk input data from a plurality of data input sources 102 for analyzing against a risk scenario and generating a risk mitigation plan when risks are identified. The risk mitigation modeler 108a selects (204) a risk scenario to be applied to the risk input data, from a plurality of risk scenarios. In some embodiments, the modeler 108a selects multiple risk scenarios for application to the risk input data.

The risk mitigation modeler 108a analyzes (206) the risk input data using the selected risk scenario to identify one or more risks present in the risk input data. As mentioned above, in one embodiment the modeler 108a analyzes the risk input data in view of one or more risk tolerances as defined in the risk scenario. If elements of the risk input data, alone or in aggregate, meet or exceed at least one of the risk tolerances associated with the risk scenario(s), the risk mitigation modeler 108a determines (208) a risk remediation plan based upon the risk scenario(s) to address the current risks and, in some cases, to mitigate against future risks of the same or similar type.

The risk remediation plan comprises a set of instructions generated to alter information in a target production computing system (e.g., 112) so as to remediate the identified risk. For example, the risk remediation plan can include a batch job that, when executed by the target production computing system 112, updates data in the target production computing system 112 in a manner that remediates deficiencies in the data used by the production system or changes data in the production computing system 112 to affect the scope of security profiles or parameters associated with the production system. Other exemplary instructions can include updating data to prevent unauthorized access to the production system, removal of fraudulent transactions entered into the production system, and alteration of a workflow processing/routing framework to avoid potentially compromised or unavailable production workflow servers.

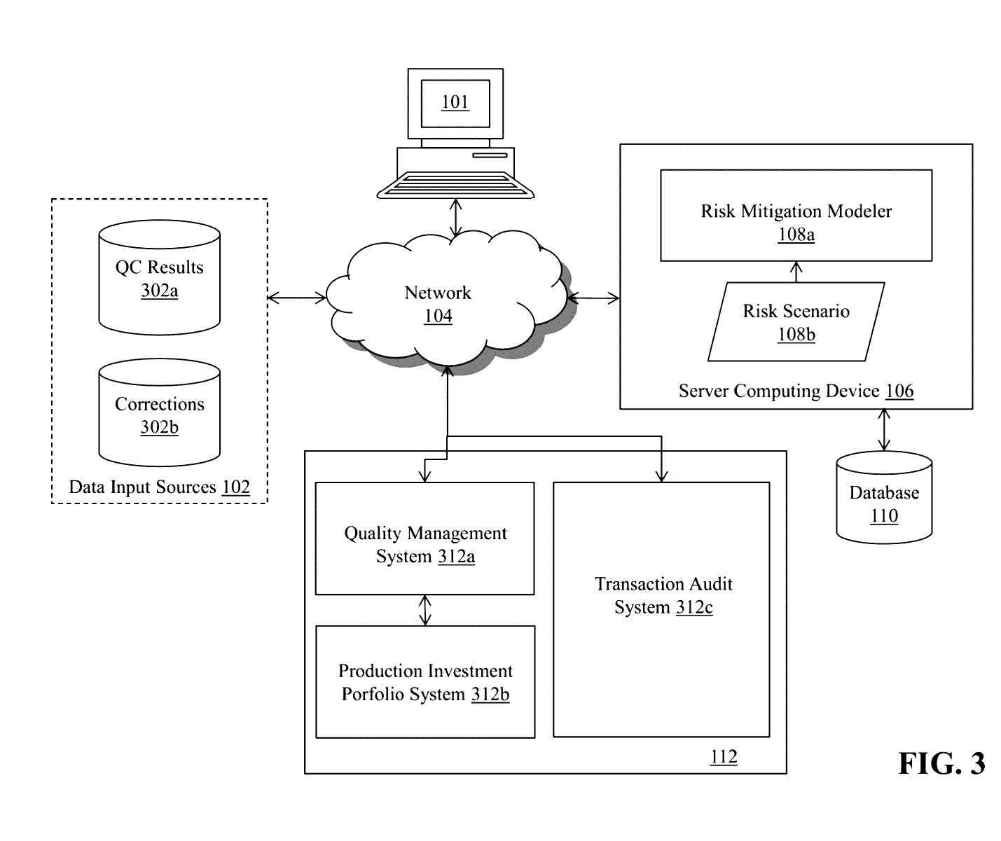

FIG. 3 is a block diagram of a system for analyzing and remediating process quality control risks, based upon the system 100 of FIG. 1. The data input sources 102 include a quality control (QC) results database 302a and a data corrections database 302b. The risk mitigation modeler 108a receives risk input data from the QC results database 302a and the data corrections database 302b that pertains to, e.g., a transaction processing workflow for a production investment portfolio system 312b. For example, the risk input data received from the databases 302a and 302b may indicate (i) that data associated with a particular transaction contains a certain percentage of discrepancies (e.g., missing data, errors, unusual values) and/or (ii) that data associated with a particular transaction has been subject to a certain percentage of corrections during a specific time period.

The risk mitigation modeler 108a determines that the incoming risk input data is associated with a particular transaction and retrieves a risk scenario 108b associated with the transaction in some way. For example, the risk scenario 108b can be specific to the transaction or related to a business unit that processes the transaction. The risk scenario 108b includes risk tolerance criteria for the transaction, such as a threshold percentage of discrepancies in the data and/or corrections made to the data that, if met or exceeded, is indicative of an adverse risk to the organization—like data loss, monetary loss, reputational loss, fraud risk, and the like. For example, the risk scenario 108b can be defined with a risk tolerance of 3% data discrepancy, and the data mitigation modeler 108a can determine that the received risk input data indicates 50 discrepancies out of 1,000 transactions (or 5%). As a result, the risk mitigation modeler 108a identifies that the current set of risk input data exceeds the specified risk tolerance and therefore a risk is present in the transaction processing workflow for the production investment portfolio system 312b.

Based upon this information, the risk mitigation modeler 108a generates a risk mitigation plan to address the risk. Continuing with the above example, the modeler 108a generates a risk mitigation plan that includes instructions to a quality management system 312a to increase quality control sampling (e.g., increase sample size by 10% for work items relating to the specified transaction) within the transaction processing workflow for the production investment portfolio system 312b. The risk mitigation plan can also include instructions to an internal audit system 312c to initiate an automated or manual audit of the specified transaction workflow to identify potential areas in which the quality control issues may originate. The risk mitigation modeler 108a transmits the generated risk mitigation plan to the production systems 312a and 312c. In some embodiments, the modeler 108a generates a separate risk mitigation plan for each affected production system 312a and 312c and transmits the separate plans to the respective systems.

After receiving the risk mitigation plan, the quality management system 312a executes the plan to remediate the identified risk. Continuing with the above example, the quality management system 312a populates data fields to result in a 10% increase in the quality control sampling rate for the specified transaction, in order to ensure a more comprehensive monitoring of the transaction. Also, the internal audit system 312b executes the plan to alert other systems (not shown) to review the process steps and systems involved in creating, processing, and storing the data associated with the transaction to see where the discrepancies may be occurring. For example, the internal audit system 312c may instruct the production investment portfolio system 312b to pre-fill a transaction value if that value was previously left empty and causing data discrepancies or correction requests.

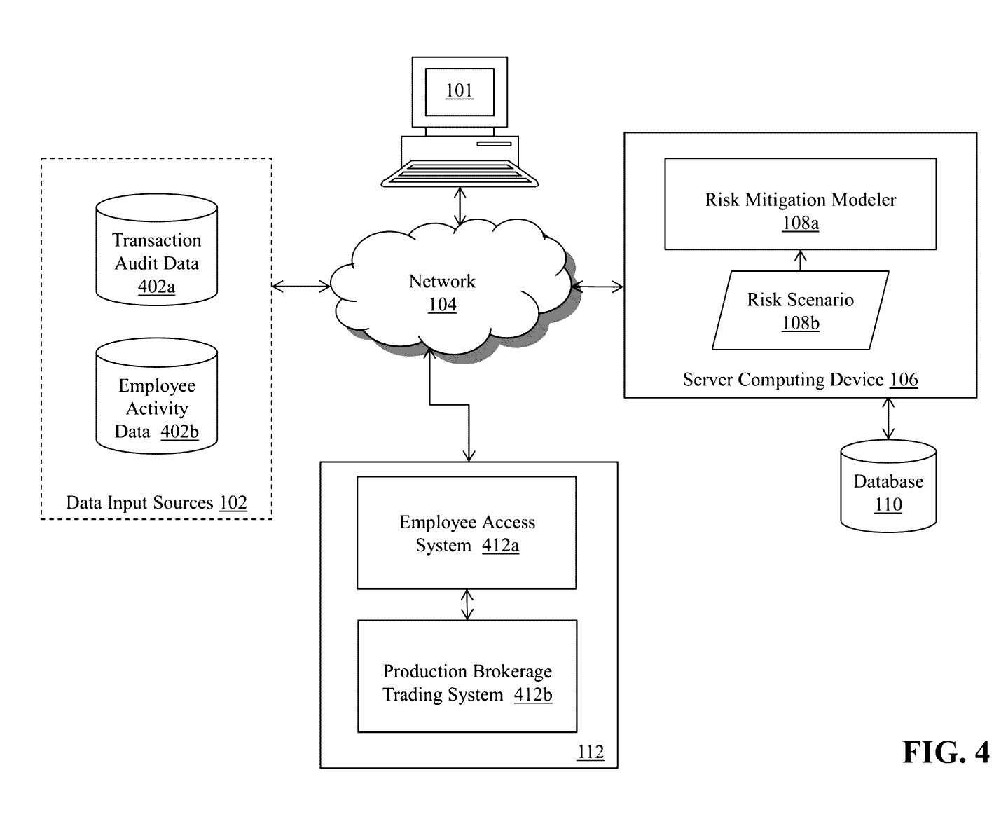

FIG. 4 is a block diagram of a system for analyzing and remediating employee error and security risks, based upon the system 100 of FIG. 1. The data input sources 102 include a transaction audit data database 402a and an employee activity database 402b. The risk mitigation modeler 108a receives risk input data from the transaction audit data database 402a and an employee activity database 402b that pertains to, e.g., performance errors for a production brokerage trading system 412b. For example, the risk input data received from the databases 402a and 402b may indicate that data associated with brokerage trades submitted by an employee or business unit contains a certain percentage of discrepancies (e.g., missing data, errors, and unusual values).

The risk mitigation modeler 108a determines that the incoming risk input data is associated with trades submitted by a certain employee and retrieves a risk scenario 108b associated with the employee and/or the trades in some way. The risk scenario 108b includes risk tolerance criteria for the transaction, such as a threshold percentage of discrepancies in the data that, if met or exceeded, is indicative of an adverse risk to the organization—like monetary loss, reputational loss, fraud risk, and the like. For example, the risk scenario 108b can be defined with a risk tolerance of five trades submitted by a single employee having data discrepancies within a single month, and the data mitigation modeler 108a can determine that the received risk input data indicates twelve discrepancies for a certain employee during the previous month. As a result, the risk mitigation modeler 108a identifies that the current set of risk input data exceeds the specified risk tolerance and therefore a risk is present in the brokerage trades submitted by the employee to the production brokerage trading system 412b.

Based upon this information, the risk mitigation modeler 108a generates a risk mitigation plan to address the risk. Continuing with the above example, the modeler 108a generates a risk mitigation plan that includes instructions to an employee access system 412a to restrict the subject employee's access to the production brokerage trading system 412b. The risk mitigation modeler 108a transmits the generated risk mitigation plan to the production employee access system 412a.

After receiving the risk mitigation plan, the employee access system 412a executes the plan to remediate the identified risk. Continuing with the above example, the employee access system 412a populates data fields and/or deletes data records associated with the employee to result in the employee no longer being authorized or able to log into the production brokerage trading system 412b.

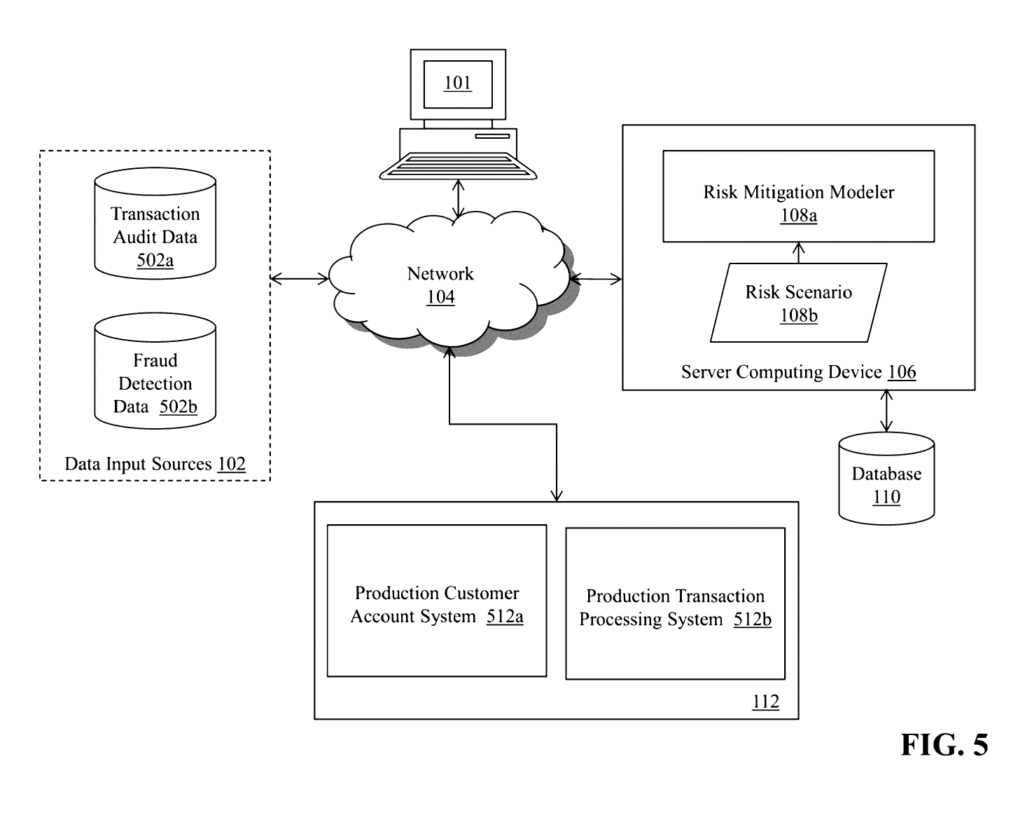

FIG. 5 is a block diagram of a system for analyzing and remediating fraudulent transaction risks, using the system 100 of FIG. 1. The data input sources 102 include a transaction audit data database 502a and a fraud detection data database 504a. The risk mitigation modeler 108a receives risk input data from the transaction audit data database 502a and a fraud detection data database 504a that pertains to, e.g., a transaction submission and/or execution workflow for a production customer account system 512b. The risk input data received from the databases 502a and 502b may indicate (i) that transaction data associated with a particular customer account indicates a potential for fraudulent activity.

The risk mitigation modeler 108a determines that the incoming risk input data is associated with a particular customer account and retrieves a risk scenario 108b associated with the customer account in some way. The risk scenario 108b includes risk tolerance criteria for the customer account that, if met or exceeded, is indicative of an adverse risk of transaction fraud. For example, the risk scenario 108b can be defined with a risk tolerance of zero customer account access attempts from geographical locations more than a certain distance apart (e.g., 3,000 miles) with in a prescribed time period (e.g., two hours), and the data mitigation modeler 108a can determine that the received risk input data indicates five login attempts for the customer account from different locations around the world within thirty minutes of each other—suggesting an attempt to hack the customer account. As a result, the risk mitigation modeler 108a identifies that the current set of risk input data exceeds the specified risk tolerance and therefore a risk is present in the production customer account system 512a.

Based upon this information, the risk mitigation modeler 108a generates a risk mitigation plan to address the risk. Continuing with the above example, the modeler 108a generates a risk mitigation plan that includes instructions to the production customer account system 512a to lock the customer account that has been subject to the multiple login attempts. The risk mitigation plan can also include instructions to a production transaction processing system 512b to freeze any currently-processing or future transactions involving the same customer account. The risk mitigation modeler 108a transmits the generated risk mitigation plan to the production systems 512a and 512b.

After receiving the risk mitigation plan, the customer account system 512a executes the plan to remediate the identified risk. Continuing with the above example, the customer account system 512a changes a flag for the customer account to lock the account from further login attempts. Also, the production transaction processing system 512b executes the plan to change flags for transactions associated with the customer account to prevent the transactions from execution.

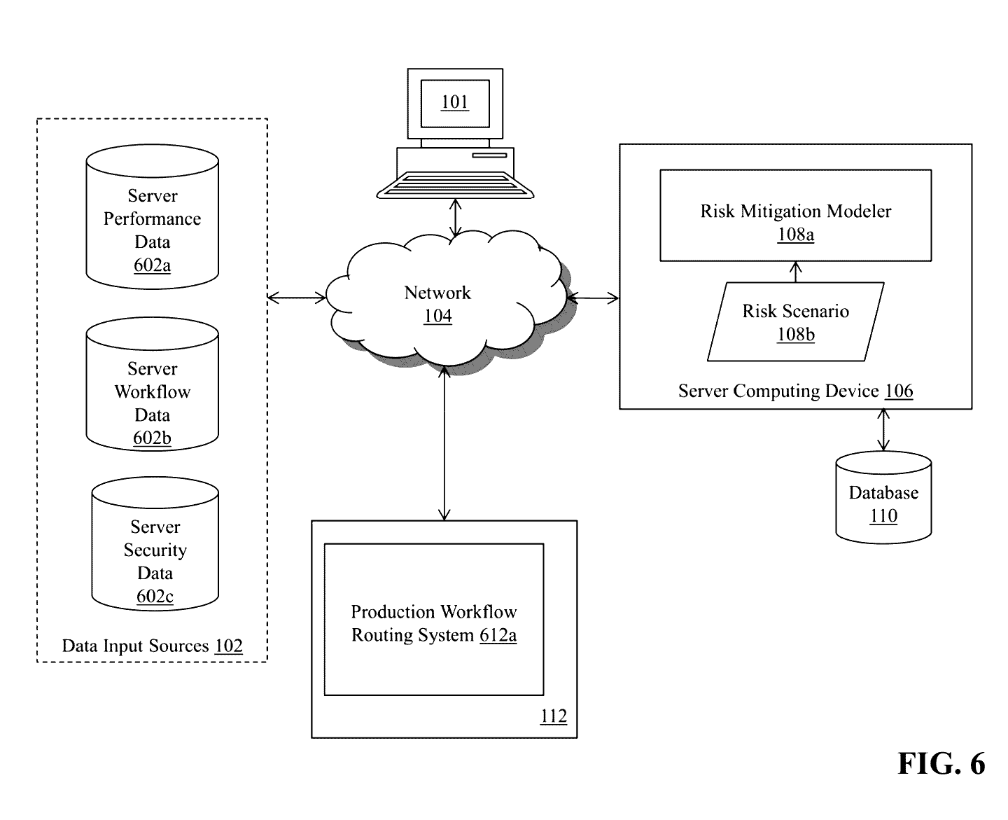

FIG. 6 is a block diagram of a system for analyzing and remediating server failure/compromise risks, using the system 100 of FIG. 1. The data input sources 102 include a server performance data database 602a, a server workflow data database 602b, and a server security data database 602c. The risk mitigation modeler 108a receives risk input data from the server performance data database 602a, a server workflow data database 602b, and a server security data database 602c that pertains to, e.g., a status of workflow servers in a production workflow routing system 612a. The risk input data received from the databases 602a, 602b, and 602c may indicate that a production workflow server may be experiencing a compromise and/or failure event. For example, the risk input data may show that a particular workflow server is offline, is overwhelmed with incoming traffic (e.g., as part of a Distributed Denial of Service (DDoS) attack), or has been accessed by an unauthorized entity.

The risk mitigation modeler 108a determines that the incoming risk input data is associated with a particular compromise and/or failure event and retrieves a risk scenario 108b associated with the event in some way. The risk scenario 108b includes risk tolerance criteria for the event that, if met or exceeded, is indicative of an adverse risk of server failure or compromise. For example, the risk scenario 108b can be defined with a risk tolerance of server has lost communication with the routing system 612a, and the data mitigation modeler 108a can determine that the received risk input data indicates a particular workflow server is no longer in communication with the routing system 612a (e.g., via network monitoring statistics, health reports, and the like). As a result, the risk mitigation modeler 108a identifies that the current set of risk input data exceeds the specified risk tolerance and therefore a risk is present in the production workflow routing system 612a—namely that workflow requests submitted to the offline server will be interrupted or lost.

Based upon this information, the risk mitigation modeler 108a generates a risk mitigation plan to address the risk. Continuing with the above example, the modeler 108a generates a risk mitigation plan that includes instructions to the production workflow routing system 612a to change a routing table to remove the affected workflow server until the server returns to normal connectivity and operation. The risk mitigation modeler 108a transmits the generated risk mitigation plan to the production system 612a.

After receiving the risk mitigation plan, the production workflow routing system 612a executes the plan to remediate the identified risk. Continuing with the above example, the production workflow routing system 612a updates a routing table stored at the system 612a to remove or demote the affected server from receiving new workflow requests while it remains offline.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for analyzing and remediating operational risks in production computing systems, the method comprising:
receiving, by a risk mitigation modeler of a server computing device, risk input data comprising workflow server availability data, workflow server traffic flow data, and workflow server security access data, from a production workflow routing system;
identifying, by the risk mitigation modeler, one or more security risks present in the risk input data, wherein the security risks include server compromise due to unauthorized access, server failure due to a high volume of incoming traffic, and server unavailability due to loss of connectivity;
selecting, by the risk mitigation modeler, a risk scenario from a plurality of risk scenarios based upon the identified security risks if at least one of the identified security risks meets or exceeds a risk tolerance associated with the selected risk scenario;
determining, by the risk mitigation modeler, one or more server computing devices managed by the production workflow routing system that are affected by the identified security risks;
determining, by the risk mitigation modeler, a risk remediation plan based upon the selected risk scenario, wherein the risk remediation plan comprises instructions to change a value of one or more data elements that directly relate to remediation of the identified security risks at the affected server computing devices;
transmitting, by the risk mitigation modeler, the risk remediation plan to the production workflow routing system; and
executing, by the production workflow routing system, the risk remediation plan to change a value of one or more data elements in the production workflow routing system; and
based upon recognition of the changed value by the production workflow routing system, interdicting, by the production workflow routing system, subsequent workflow traffic routing and security access requests intended for the affected server computing devices while the identified security risks are unresolved,
wherein during interdiction:
if the identified security risk is server compromise due to unauthorized access, locking a system resource identified in the workflow traffic routing and security access requests to prevent further access;
if the identified security risk is server failure due to a high volume of incoming traffic, identifying unaffected server computing devices having available processing bandwidth to accept the workflow traffic routing and security access requests and diverting a first portion of the workflow traffic routing and security access requests to the alternate server computing devices while continuing to route a second portion of the workflow traffic routing and security access requests to the affected server computing devices; and
if the identified security risk is server unavailability due to loss of connectivity, identifying alternate server computing devices having application resources capable of servicing the workflow traffic routing and security access requests and diverting the workflow traffic routing and security access requests to the alternate server computing devices.

2. The method of claim 1, further comprising transmitting, by the production workflow routing system, one or more data elements associated with execution of the risk remediation plan to be used by the risk mitigation modeler as risk input data.

3. (canceled)

4. The method of claim 1, wherein the risk remediation plan is a batch job that, when executed, changes data flags in the production workflow routing system.

5. The method of claim 1, wherein the risk remediation plan is a batch job that, when executed, populates data fields in the production workflow routing system.

6. The method of claim 1, wherein the risk remediation plan is a command that, when executed, updates a transaction routing table in the production workflow routing system.

7. The method of claim 1, wherein the risk remediation plan is a command that, when executed, updates a network traffic routing table in the production workflow routing system.

8. The method of claim 1, wherein the risk mitigation modeler transmits the risk remediation plan to a plurality of production workflow routing systems and each production workflow routing system executes at least a portion of the risk remediation plan.

9. The method of claim 1, further comprising:
generating, by the risk mitigation modeler, a display of the risk input data, the selected risk scenario, and the risk remediation plan; and
transmitting, by the risk mitigation modeler, the display to a remote computing device.

10. The method of claim 1, wherein the risk tolerance comprises a number of security risks identified over a predetermined time period.

11. The method of claim 1, further comprising:
storing, by the risk mitigation modeler, the risk input data in a data store; and
using, by the risk mitigation modeler, the stored risk input data to modify the risk scenarios.

12. The method of claim 1, wherein the risk scenarios are generated based upon input received from a remote computing device.

13. A computerized system for analyzing and remediating operational risks in production computing systems, the system comprising
a risk mitigation modeler of a server computing device, the risk mitigation modeler being configured to
receive risk input data comprising workflow server availability data, workflow server traffic flow data, and workflow server security access data, from a production workflow routing system;
identify one or more security risks present in the risk input data, wherein the security risks include server compromise due to unauthorized access, server failure due to a high volume of incoming traffic, and server unavailability due to loss of connectivity;
select a risk scenario from a plurality of risk scenarios based upon the identified security risks if at least one of the identified security risks meets or exceeds a risk tolerance associated with the selected risk scenario;
determine one or more server computing devices managed by the production workflow routing system that are affected by the identified security risks;
determine a risk remediation plan based upon the selected risk scenario, wherein the risk remediation plan comprises instructions to change a value of one or more data elements that directly relate to remediation of the identified security risks at the affected server computing devices; and
the production workflow routing system being configured to
receive the risk remediation plan from the risk mitigation modeler;
execute the risk remediation plan to change a value of one or more data elements in the production workflow routing system; and
based upon recognition of the changed value by the production workflow routing system, interdict subsequent workflow traffic routing and security access requests intended for the affected server computing devices while the identified security risks are unresolved,
wherein during interdiction:
if the identified security risk is server compromise due to unauthorized access, locking a system resource identified in the workflow traffic routing and security access requests to prevent further access;
if the identified security risk is server failure due to a high volume of incoming traffic, identifying unaffected server computing devices having available processing bandwidth to accept the workflow traffic routing and security access requests and diverting a first portion of the workflow traffic routing and security access requests to the alternate server computing devices while continuing to route a second portion of the workflow traffic routing and security access requests to the affected server computing devices; and
if the identified security risk is server unavailability due to loss of connectivity, identifying alternate server computing devices having application resources capable of servicing the workflow traffic routing and security access requests and diverting the workflow traffic routing and security access requests to the alternate server computing devices.

14. The system of claim 13, wherein the production workflow routing system is further configured to transmit one or more data elements associated with execution of the risk remediation plan to be used by the risk mitigation modeler as risk input data.

15. (canceled)

16. The system of claim 13, wherein the risk remediation plan is a batch job that, when executed, changes data flags in the production workflow routing system.

17. The system of claim 13, wherein the risk remediation plan is a batch job that, when executed, populates data fields in the production workflow routing system.

18. The system of claim 13, wherein the risk remediation plan is a command that, when executed, updates a transaction routing table in the production workflow routing system.

19. The system of claim 13, wherein the risk remediation plan is a command that, when executed, updates a network traffic routing table in the production workflow routing system.

20. The system of claim 13, wherein the risk mitigation modeler is further configured to transmit the risk remediation plan to a plurality of production workflow routing systems and each production workflow routing system executes at least a portion of the risk remediation plan.

21. The system of claim 13, wherein the risk mitigation modeler is further configured to
generate a display of the risk input data, the selected risk scenario, and the risk remediation plan; and
transmit the display to a remote computing device.

22. The system of claim 13, wherein the risk tolerance comprises a number of security risks identified over a predetermined time period.

23. The system of claim 13, wherein the risk mitigation modeler is further configured to
store the risk input data in a data store; and
use the stored risk input data to modify the risk scenarios.

24. The system of claim 13, wherein the risk scenarios are generated based upon input received from a remote computing device.

25. A computer program product, tangibly embodied in a non-transitory computer readable storage medium, for analyzing and remediating operational risks in production computing systems, the computer program product including instructions operable to cause a risk mitigation modeler of a server computing device to
receive risk input data comprising workflow server availability data, workflow server traffic flow data, and workflow server security access data, from a production workflow routing system;
identify one or more security risks present in the risk input data, wherein the security risks include server compromise due to unauthorized access, server failure due to a high volume of incoming traffic, and server unavailability due to loss of connectivity;
select a risk scenario from a plurality of risk scenarios based upon the identified security risks if at least one of the identified security risks meets or exceeds a risk tolerance associated with the selected risk scenario;
determine one or more server computing devices managed by the production workflow routing system that are affected by the identified security risks;
determine a risk remediation plan based upon the selected risk scenario, wherein the risk remediation plan comprises instructions to change a value of one or more data elements that directly relate to remediation of the identified security risks at the affected server computing devices;
execute, by the production workflow routing system, the risk remediation plan to remediate the identified security risks, wherein the risk remediation plan operates to change a value of one or more data elements in the production workflow routing system; and
based upon recognition of the changed value by the production workflow routing system, interdict subsequent workflow traffic routing and security access requests intended for the affected server computing devices while the identified security risks are unresolved,
wherein during interdiction:
if the identified security risk is server compromise due to unauthorized access, locking a system resource identified in the workflow traffic routing and security access requests to prevent further access;
if the identified security risk is server failure due to a high volume of incoming traffic, identifying unaffected server computing devices having available processing bandwidth to accept the workflow traffic routing and security access requests and diverting a first portion of the workflow traffic routing and security access requests to the alternate server computing devices while continuing to route a second portion of the workflow traffic routing and security access requests to the affected server computing devices; and
if the identified security risk is server unavailability due to loss of connectivity, identifying alternate server computing devices having application resources capable of servicing the workflow traffic routing and security access requests and diverting the workflow traffic routing and security access requests to the alternate server computing devices.
